(19) United States
(12) Patent Application Publication
(10) Pub. No.: US 2015/0008242 A1
(43) Pub. Date: Jan. 8, 2015

(54) Multipurpose nozzle access door, content management insert, and anchor for a flexible cooler and dispenser alternative

(71) Applicant: Thomas Kolaco Kpabar, JR., Bloomington, IN (US)

(72) Inventor: Thomas Kolaco Kpabar, JR., Bloomington, IN (US)

(21) Appl. No.: 14/120,890

(22) Filed: Jul. 7, 2014

Related U.S. Application Data
(60) Provisional application No. 61/957,578, filed on Jul. 8, 2013.

(51) Int. Cl. B67D 3/00; F25D 31/00

(52) U.S. Cl. CPC B67D 3/0061; F25D 31/002; B67D 3/0029
USPC 222/183; 222/146.6

(57) ABSTRACT

A multipurpose nozzle access door, content management insert, and anchor for a flexible cooler and dispenser alternative is an insulated beverage cooler/utility bag body that accepts a waterproof and water tight content management insert. The content management insert lines the inside of the cooler body and is fastened to selected portion of the interior of the cooler body. In concert the liner covers the entire inner cavity which is the storage space of the cooler. Individually the liner permits arrangement, separation, variable insulation of items placed in the cooler storage space. The cooler has a cascading door with a cancelable cup holder attached. Additionally, the cooler has two types of anchors that allow the carrying strap to act as the linkage between the cooler body and either one of the anchors so that the cooler can be restrained near a fixed point.

### CROSS REFERENCE TO RELATED APPLICATIONS

This application claims the benefits of U.S. Provisional Patent Application 61/957,578 Filled on Jul. 8, 2013.

### BACKGROUND OF THE INVENTION

1. Field of Invention

Multipurpose food and beverage storage and water dispenser alternatives provide many advantages to include protection of beverage nozzles from unwanted access by, among other creatures, pets and insects. However, space management is a primary concern for these types of coolers and dispenser alternatives that are stowed after use or during transportation.

In view of concerns associated with plastic bottles left in direct sunlight, content concealing containers, in this case the cooler and dispenser alternative, have a wider range of usage. These containers can be used in the office and at home as a cooler, dispenser, and lunch pails, and outdoors as a utility bag, cooler, dispenser, and lunch pail. The content concealing containers provides a portable means of concealing items that are essential to comfort. None the less, the ever present need for outdoor inhabited areas, homes, and offices to be hospitable while maintaining less cumbersome spaces that are free of egress and ingress obstacle also drives the need for enhancements to food and beverage concealing containers which improve ease of use and ease of stowing capabilities.

Additionally, an all-in-one and safely anchored cooler and dispenser option will serve parents that are supervising young children, who are learning subjects in addition to their ABCs, the fundamentals of being independently responsible for healthy fluid consumption. This is done by allowing parents to be more certain that the cooler and dispenser alternative will not fall onto the floor when being used.

There is also a need for coolers with arranged inserts and attachments such as cup holders that are flexible, in terms of less rigidity, enough to be compressed and stowed so as not to negatively impose on space limits when they are removed from or kept in these containers that themselves can be compressed and stowed.

Furthermore flexible manufacturing capability that is being developed for industrial sewing application makes more attractive the development of solutions whose methods of mating components and subcomponents are similar to those methods made available using well known and frequently used sewing processes.

2. Description of Prior Art

U.S. Pat. No. 8,459,058 issued on Jun. 11, 2013 to Mogil and Melvin S. discloses a soft side insulated container assembly that has an insert. However the patent issued to Mogil and Melvin S. does not disclose an insert that can be arranged in the cooler body and one that collapses to improve the cooler's, when-not-in-use, stowing capability.

U.S. Pat. No. 6,629,722 issued on Oct. 7, 2003 to Tang; Larry discloses a cooler/utility bag and cup holder that collapse for when-not-in-use stowage. Never the less, the patent issued to Tang does not disclose a cooler/utility bag with collapsing content management insert and a cooler/utility bag cascading door member that is capable of concealing the cup holder.

U.S. Pat. No. 6,446,382 issued on Sep. 10, 2002 to Cloutier, et al. discloses a combination food cooler and fishing tackle that has a retractable cup holder. However the patent issued to Cloutier, et al. does not disclose a cooler with a cup holder that is concealable by the closure of a cascading door member or one that conceals by rotation about a pivot point connection to the cascading door member.

### BRIEF SUMMARY OF THE INVENTION

The present invention relates generally to a multipurpose nozzle access door, content management insert, and anchor for a flexible cooler and dispenser alternative. The aforementioned cooler and dispenser alternative is capable of concealing in an enclosed environment, a dimensionally appropriate water container that can be accessed by unzipping the cascading door. The cascading door functions includes acting as a cup support and cup rest when the cascading door is fully opened. When the environment formed by the inside of the cooler's body is empty or partial empty a waterproof content management insert is fastened inside of the cooler body to contain material that liquefies such as ice. More specifically, this invention is a multipurpose door, contentment management insert and anchoring system for a flexible insulated container.

Accordingly, it is a principle object of the inventor to provide a multipurpose nozzle access door, content management insert, and anchor for a flexible cooler and dispenser alternative whose interior region permits the insertion of content management inserts and whose door further functions as a cup support while providing unobstructed flow for a nozzle contained in the cooler body to a cup which is held beneath the nozzle.

It is another object of the invention with the above attributes to provide a nozzle access door, which is the cascading door, with a cup holder attached.

It is a further object of the invention with the above attributes to provide a cup holder that pivot about a connection point on the cascading door into a position that allows the portion of an area that is opposite, along the cup support structure, of the pivot point to be fastened to the nozzle access door.

It is a further object of the invention with the above attributes to provide a cup holder that is concealable by two methods. The first method being that the cascading door is shut and the second being that the cup holder is lifted into the position that allow the area opposite to the pivot point, along the cup support structure length, to be fastened to the nozzle access door.

It is a further object of the invention with the above attributes to provide a cup holder that is concealed using either of two methods that involves no automation.

It is a further object of the invention with the above attributes to provide a content management insert that is a water proof and watertight flexible structure that inserts into the cooler to divide the content storage area of the cooler body.

It is a further object of the invention with the above attributes to provide a content management insert that collapses into a relatively flat geometry whose flatness is maintained by, i.e. held together, by fastener that are attached to the interior part of inserts.

It is a further object of the invention with the above attributes to provide a cooler with a content storage area that allows more than one content management insert to be arranged and fastened to the cooler body content storage area so as to prevent non-resisted shifting of the inserts to an out of intended arranged position.

Still another object of the invention is to provide a flexible container with an anchor that allows the container carrying strap to be used as the linkage between the anchor and the container.

It is an object of the invention to provide a unit comprising of the individual components and assemblies described above for the purpose described above to provide an enhancement to existing water dispensing units, strapped container, and cooler or ice chests.

These and other objects of the present invention will become readily apparent upon further reviewing of the specification and drawings.

### BRIEF DESCRIPTION OF THE SEVERAL VIEWS OF THE DRAWINGS

FIG. 1 is the content management insert next to, the cooler body which has attached the cooler handle, side pocket, top lid, cascading door, and zippers. The fully assembled cooler is shown with the cascading door open and the nozzle container placed inside of the cooler body in the content storage area. The content management insert is shown outside of the cooler. The anchor point are shown unconnected to the cooler strap and oriented as they would be when they are installed on a wall or desk top's edge. A cup is shown seated in the cup support member of the cascading door. The cup is also shown beneath the nozzle of the container placed inside of the cooler body. The strap is attached to the cooler body and the top lid is show in the open position.

FIG. 2 is the body vertical members all sewn together to form the body vertical member assembly. The body vertical member assembly is positioned above body base. This view shows the parts of the cooler body that will be the outside surface area of the cooler body.

FIG. 3 is the body vertical members sewn to body base. In this view the body vertical member assembly is still being distinguished from the body base using the reference number.

FIG. 4 is the rear insulation, left side insulation, right side insulation, base insulation, and front insulation oriented and generally position relative to one another as they would be when installed in the cooler body.

FIG. 5 is the body vertical member assembly sewn to body base with the rear insulation, left side insulation, right side insulation, and front insulation attached to body vertical member assembly and the base insulation attached to the body base.

FIG. 6 is the configuration described in FIG. 5 with body inner lining positioned above. The body inner liner has attached a Velcro-strip faster attached to the inside parameter of the inner liner. The geometry of the inner liner is such that the cascading door opening is present.

FIG. 7 is the body vertical member assembly sewn to body base with the configuration described in FIG. 5 having the body inner liner seated and sewn to the cascading door frame. Above the top of the body vertical member assembly is the excess material of the cooler body inner liner

FIG. 8 is the configuration described in FIG. 7 with the excess liner portion, which was shown in FIG. 7 as being extended above the body vertical member assembly, pulled down so as to drape over the top of the body vertical member assembly.

FIG. 9 is the configuration described in FIG. 8 having a rim formed of one piece that is folded about its general horizontal center and distributed over the top of the body vertical member assembly to cover the draped portion of the body inner liner. The rim is sewn so that one side of the folded rim attaches to the opposite side of the rim, fold with the top of the vertical member assembly, and draped portion of the body inner liner that is sandwiched between the two general halves formed by the folded rim piece.

FIG. 10 is the configuration described in FIG. 9 having the zipper tape sewn to the top of the folded rim that is at the top of the cooler body and the zipper tape sewn to the door frame formed by the vertical body member assembly and the body base for the cascading door.

FIG. 11 is the configuration shown in FIG. 10 with the fully assembled cascading door attached to the body base.

FIG. 12 is a view of the parts that make up the assembly described in FIG. 11 as the fully assembled cascading door. In this view the majority of the individual pieces of the cascading door assemble are show exploded. Some parts are shown still combine.

FIG. 13 is the configuration shown in FIG. 11 with the top lid member shown in position of attaching. The connector piece that is between the top lid and the body is shown folded as it would be when connected to the body as it is show oriented and top lid as it is shown oriented. The top lid is shown with the lid zipper tape attached.

FIG. 14 is the configuration described in FIG. 13 after it is fully assembled. This view shows the cooler with lid open as it would be when placing a beverage container, with the dimensional proportions shown, into the cooler.

FIG. 15 is the configuration described in FIG. 13 with the water container sitting inside the cooler body and a cup position in the cup holder of the cascading door.

FIG. 16 is the configuration described in FIG. 13 with the cascading door closed and the beverage container removed from the cooler. A zipper is shown to indicate the method of fastening together the zipper tap attached to the cooler body and the zipper tape attached to the cascading door. The content management insert is introduced in this view. The content management insert is shown fully assembled.

FIG. 17 is the fully assembled cooler body having the top lid open and the cascading door closed with the content management insert place inside of the cooler body.

FIG. 18 is the fully assembled cooler body having the top lid open and the cascading door closed with the content management adjusted and arranged so that the area that is part of the cooler body assembly is visible. This view also shows the compressed member of the content management insert still in the cooler.

FIG. 19 is a view similar to the view shown in FIG. 18. However in this view, the opposite content management insert is compressed and the other is positioned, i.e. arranged. This view indicates that this arrangement allows the cascading door to be used to access the cooler's content storage area while the materials held in the uncompressed and arranged content management insert remains uninterrupted.

FIG. 20 is the fully assembled cooler with the top lid and the cascading door zipped closed. This view shows the carrying strap attached to the cooler. This also references the individual members of the carrying strap.

FIG. 21 is the same view as FIG. 20 except that the parent level reference numbers are provided so as to simplify discussion of the invention.

FIG. 22 is the cooler with all door members closed and with one end of the carrying strap detached from the cooler body and attached to the desk top anchor point.

### DETAILED DESCRIPTION OF THE INVENTION

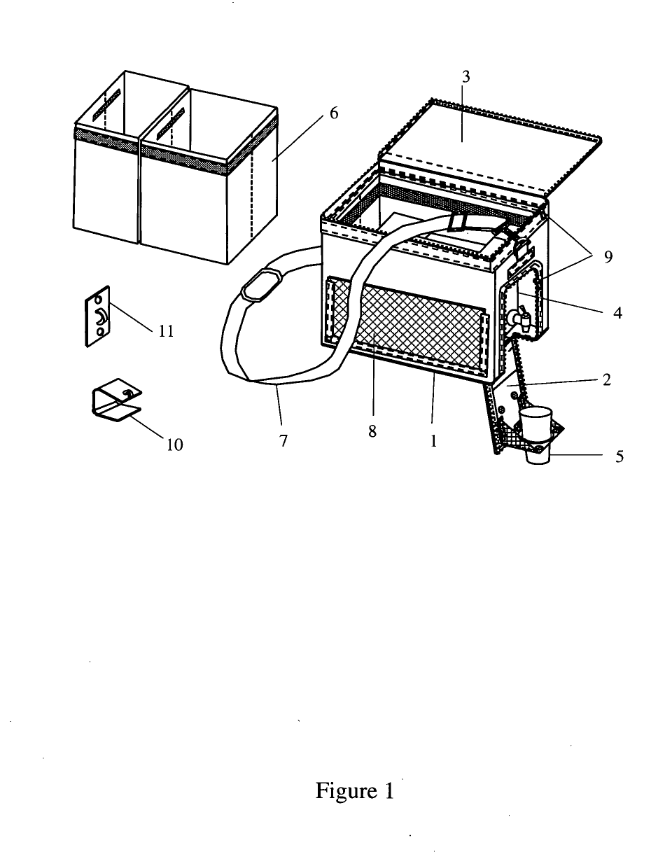

Referring to FIG. 1 through 22 the present invention is a cascading multipurpose door, content management insert and anchoring system for a dispenser alternative. The present invention combines a number of features which are meant to provide a combined non-mechanized cascading door and cup holder, a watertight inner cavity liner that can be inserted, arranged, and removed, and an anchoring mechanism for the cooler. The present invention is shown to comprise: a Cooler Body (1) with storage capability that has sewn to it, a Cascading Door (2) that partially conceals the storage cavity and when open, supports a cup holder assembly; a Cooler Lid (3) that conceals the large and upper part of the Cooler Body (1); a Detachable Cooler Handle (7) that has attach and detach function for carry the cooler when totally attached to Cooler Body (1) and for constraining to the Table Top Anchor (10) or Wall Mounted Anchor (11) went attached to the Cooler Body (1) and Table Top Anchor (10) or Wall Mounted Anchor (11); a Content Management Insert (6) that slides into the storage cavity of Cooler Body (1) so that a watertight boundary is formed for containing condensation or those effects produced by melting ice and for separating the storage cavity so that the Cascading Door (2) can be opened while the Content Management Insert (6) contains condensate or melting ice without water spilling through Cascading Door (2); Zippers (9) placed on the Cooler Body (1) and Cascading Door (2) so that the Zippers (9) can be used to hold shut or release into open position the Cooler Lid (3) and/or the Cascading Door (2); and a Side Pocket (8) for stowage of the Content Management Insert (6) when it is not in use or for stowage of other dimensionally suitable items.

Referring to FIG. 1 the Cooler Body (1) has sewn to it a Cascading Door (2) which permits a Cup (5) to be supported beneath a Water Bottle (4), a Cooler Lid (3) which is also sewn to Cooler Body (1) that conceals the opening that permits the Water Bottle (4) of any suitable dimensions to be seated inside the Cooler Body (1), a Content Management Insert (6) that is a water tight flexible liner that can be inserted in the Cooler Body (1), arranged in Cooler Body (1) and removed from the Cooler Body (1) folded and stowed in the Side Pocket (8) which is a pocket sewn to Cooler Body (1), a Detachable Cooler Handle (7) that attaches to the Cooler Body (1) so that the distributed weight of the Cooler Body (1) and its contents can be more concentrated on point handling during tote, or attached to either the Table Top Anchor (10) which is a table and desk mounted anchoring point or the Wall Mounted Anchor (11) which is a flat mounted anchoring point. The Wall Mounted Anchor (11) and the Table Top Anchor (10) are shown uncoupled from the Cooler Body (1). The Content Management Insert (6) is shown outside of the Cooler Body (1). The Cascading Door (2) is shown in the open and fully cascaded position with a Cup (5) seated in it. The Zipper (9) is shown disconnected from the zipper tracks of the Cooler Lid (3) and Cascading Door (2). A Water Bottle (4) is shown inside of Cooler Body (1) and has a part of its construct, specifically the nozzle, directly above Cup (5).

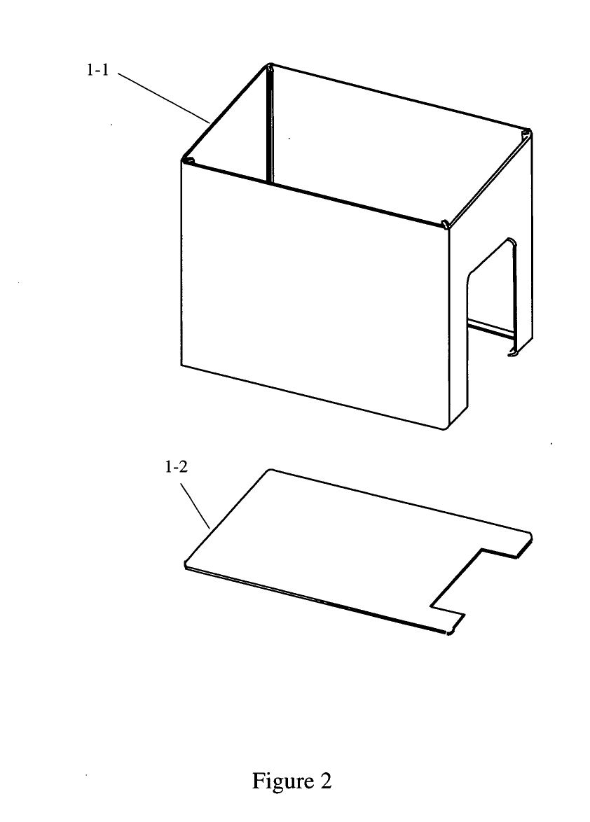

Referring to FIG. 2 the Vertical Body Member (1-1) is the outer flexible structure of the Cooler Body (1) that is perpendicularly oriented to the unattached Body Base Member (1-2). This view shows that the Vertical Body Member (1-1) is formed by four pieces that are all square shaped waterproof fabric pieces with the front piece having an additional feature which is a door opening. The excess material near seams of the Vertical Body Member (1-1) is shown as facing inward and the resulting smoother surface is facing outward. This view also shows the shape of the Body Base Member (1-2). The Body Base Member (1-2) is a waterproof fabric with a cut out feature which provides an unimpeded path. The Body Base Member (1-2) is place as a base to form what will be a cubic geometry with unimpeded paths.

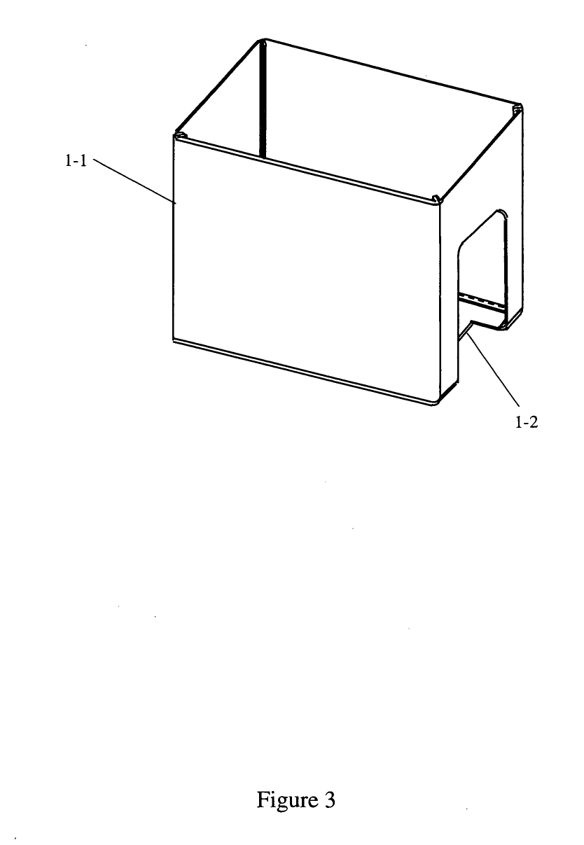

Referring to FIG. 3 the Vertical Body Member (1-1) and the Body Base Member (1-2) are sewn together so that excess material is inward and the outward surface appear with only mating seam shown. The openings of the Vertical Body Member (1-1) and the Body Base Member (1-2) are overlapped so that they together make a larger opening which has unimpeded vertical and horizontal space attributes. The inside seam are all treated for watertight effects.

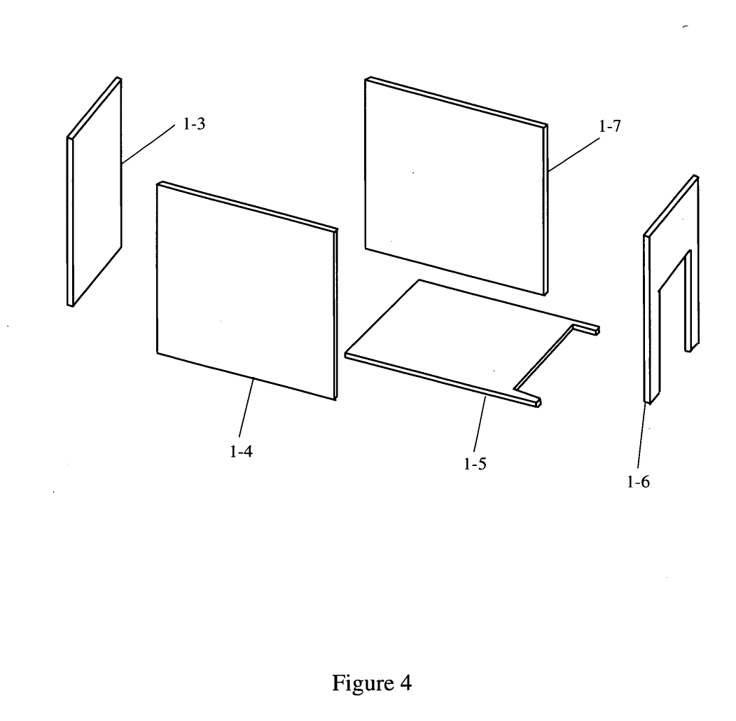

Referring to FIG. 4 the Back Wall Insulation (1-3) is the rear insulation member, the Left Wall Insulation (1-4) is the left side insulation member, the Right Wall Insulation (1-7) is the right side insulation member, and the Cascading Door Insulation (1-6) is the front insulation member cutout geometry commensurate to a door frame feature. The Back Wall Insulation (1-3), Left Wall Insulation (1-4), Right Wall Insulation (1-7) and Cascading Door Insulation (1-6) are all oriented as they would be when assembled. The Base Insulation (1-5) is the base insulation member. The Base Insulation (1-5) is shown oriented horizontally with respect to the Back Wall Insulation (1-3), Left Wall Insulation (1-4), Right Wall Insulation (1-7) and Cascading Door Insulation (1-6). The Base Insulation (1-5) has cutout geometry commensurate to an unimpeded space.

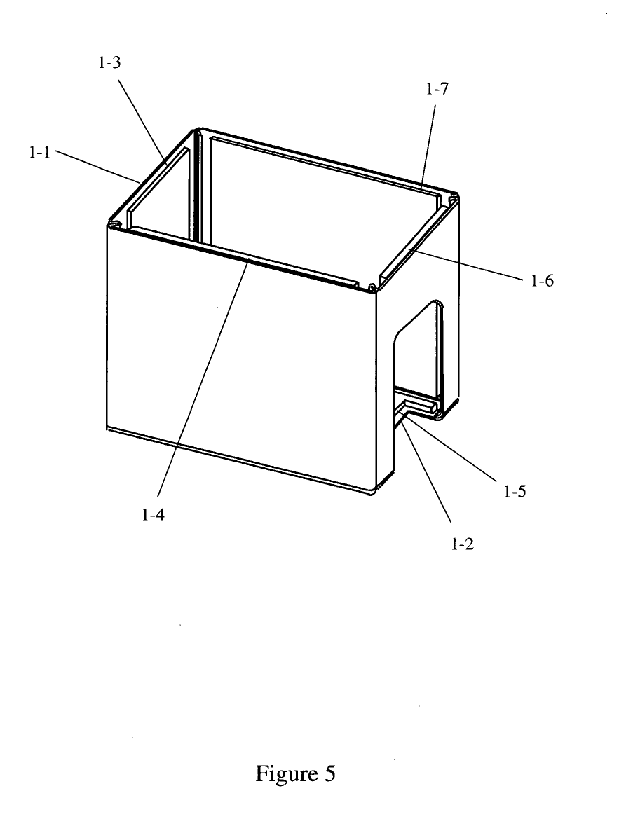

Referring to FIG. 5 the Vertical Body Member (1-1) and the Body Base Member (1-2) has Back Wall Insulation (1-3), Left Wall Insulation (1-4), Right Wall Insulation (1-7), Cascading Door Insulation (1-6), and the Base Insulation (1-5) placed against its inward surfaces and properly align in all plains so as to insulate the maximum surface are formed by the mated Vertical Body Member (1-1) and Body Base Member (1-2). The Back Wall Insulation (1-3), Left Wall Insulation (1-4), Cascading Door Insulation (1-6), Right Wall Insulation (1-7), and Base Insulation (1-5) can be loosely fixed to the corresponding major abutted surface of Vertical Body Member (1-1) and Body Base Member (1-2) as such no adhesive is necessary.

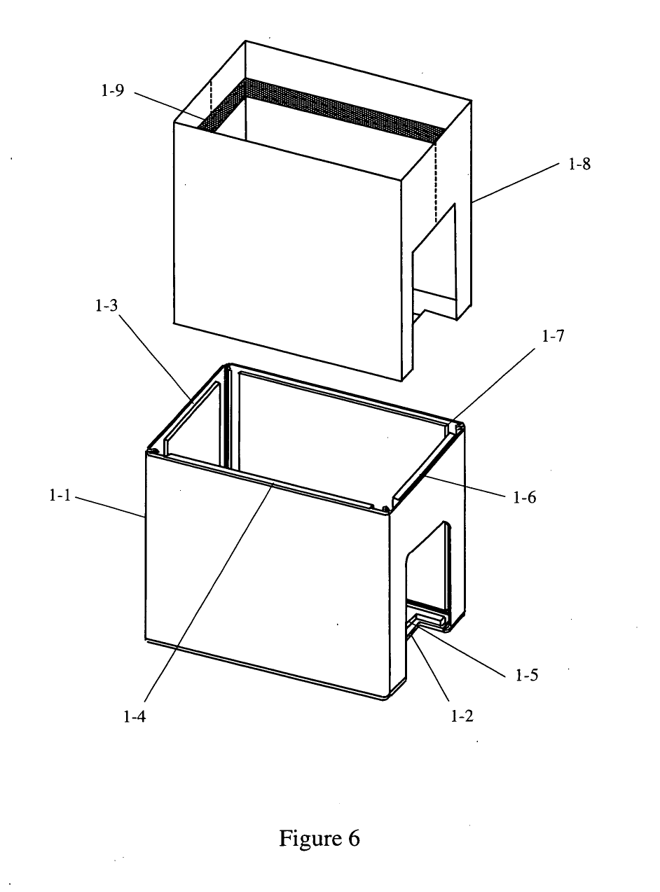

Referring to FIG. 6 the assembled Vertical Body Member (1-1), Body Base Member (1-2), Back Wall Insulation (1-3), Left Wall Insulation (1-4), Base Insulation (1-5), Cascading Door Insulation (1-6), and Right Wall Insulation (1-7) is shown beneath the Body Inner Cavity Lining (1-8) which has sewn inside the Body Inner Cavity Lining Velcro Hook (1-9). The purpose of this drawing is to provide the general construct of Body Inner Cavity Lining (1-8) and the Body Inner Cavity Lining Velcro Hook (1-9) and their orientation for insertion and mating with the already assembled Vertical Body Member (1-1), Body Base Member (1-2), Back Wall Insulation (1-3), Left Wall Insulation (1-4), Base Insulation (1-5), Cascading Door Insulation (1-6), and Right Wall Insulation (1-7). The Body Inner Cavity Lining (1-8) is a waterproof fabric that is sewn together and treated at the seams to produce watertight effects. The Body Inner Cavity Lining Velcro Hook (1-9) is sewn inside of the Body Inner Cavity Lining (1-8) and treated at the mating threading for watertight effects. The Body Inner Cavity Lining Velcro Hook (1-9) is deliberately placed so that material of the Body Inner Cavity Lining (1-8) is shown above it. The Body Inner Cavity Lining (1-8) also has shown the cutout geometry commensurate to an unimpeded space.

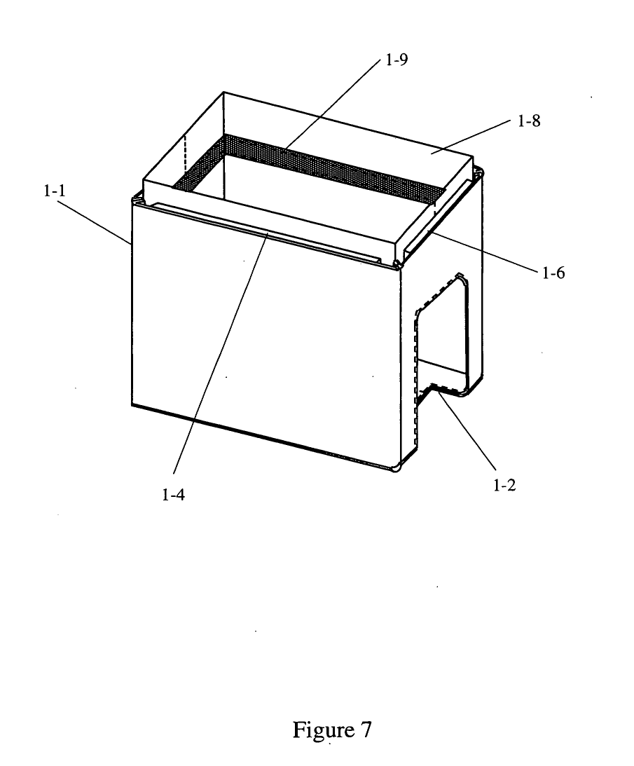

Referring to FIG. 7 the Body Inner Cavity Lining (1-8) is seated inside of the assembly described in FIG. 5. The Body Inner Cavity Lining (1-8) is seated so that it is atop and in front of the insulating members and partially shown is the Left Wall Insulation (1-4) and Cascading Door Insulation (1-6) relative to Body Inner Cavity Lining (1-8) and Body Inner Cavity Lining Velcro Hook (1-9). The edge of cutout geometry of Body Inner Cavity Lining (1-8) is aligned and sewn to the corresponding cutout edge of Vertical Body Member (1-1) and Body Base Member (1-2) with those seams of the aforementioned sewing treated to produce water tight effects.

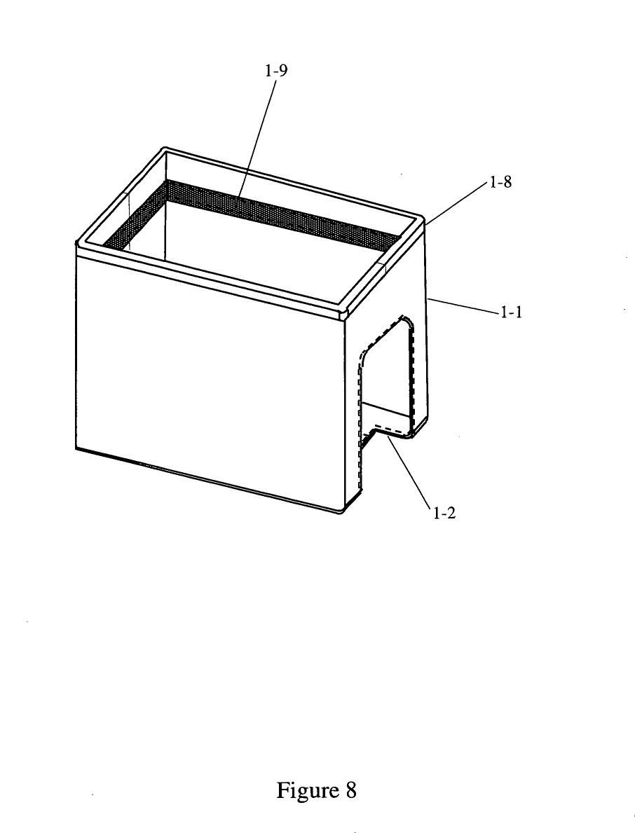

Referring to FIG. 8 the material of the Body Inner Cavity Lining (1-8) that is above the Body Inner Cavity Lining Velcro Hook (1-9) is folded over the Vertical Body Member (1-1). After the aforementioned folding of the Body Inner Cavity Lining (1-8) material over the Vertical Body Member (1-1) upper rim the visible parts are the Vertical Body Member (1-1), as the Body Base Member (1-2), Body Inner Cavity Lining (1-8) and Body Inner Cavity Lining Velcro Hook (1-9).

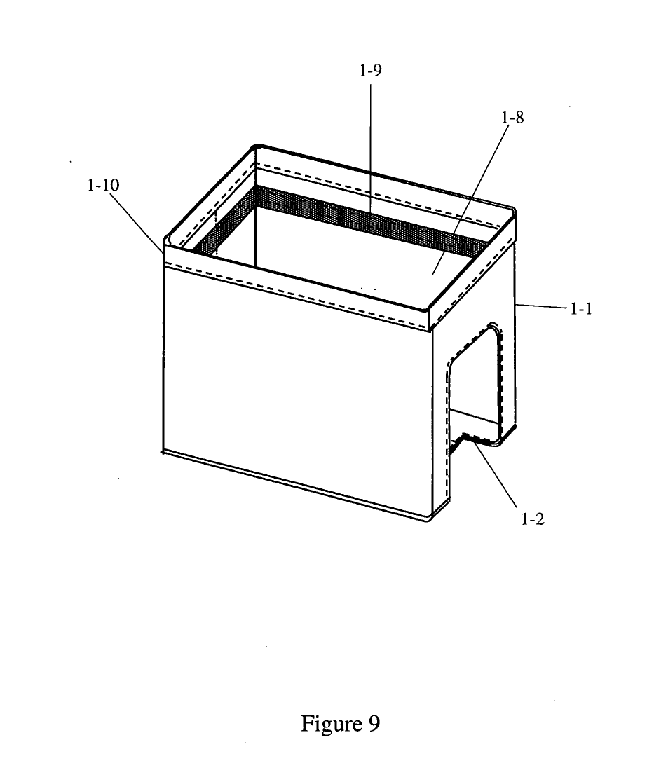

Referring to FIG. 9 the Body Rim Lining (1-10) is sewn around the upper portion of the Vertical Body Member (1-1) sealing the folded material discussed in FIG. 8. After the Body Rim Lining (1-10) is sewn onto the upper portion of the Body Inner Cavity Lining (1-8) and Vertical Body Member (1-1) all that remains visible is Body Rim Lining (1-10), Body Inner Cavity Lining Velcro Hook (1-9), Body Inner Cavity Lining (1-8), and Body Base Member (1-2).

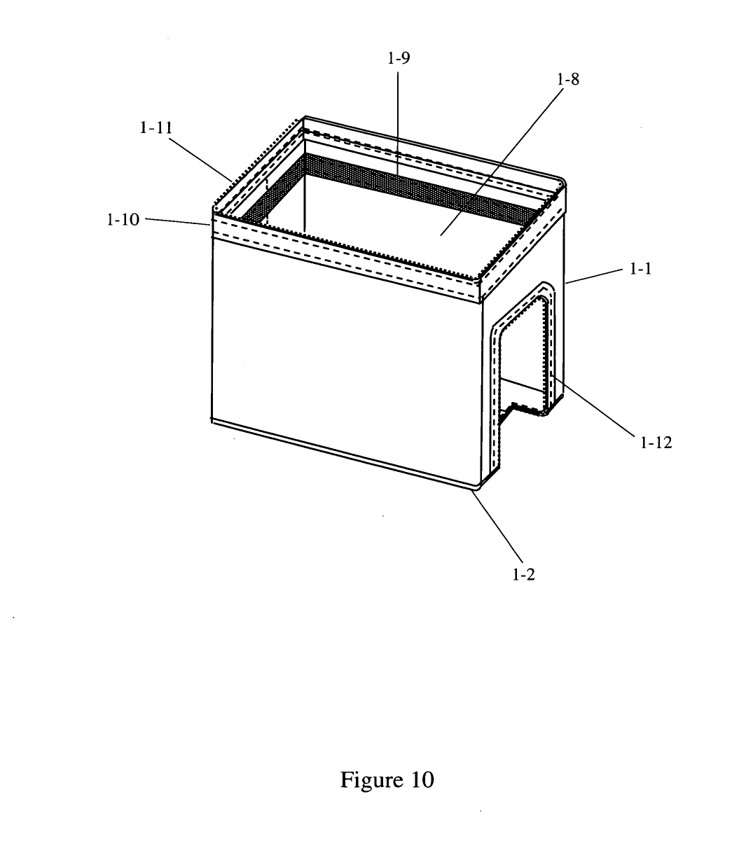

Referring to FIG. 10 the Body Rim Zipper Tape Assembly (1-11) is sewn around rear, left, and front upper rim of the Body Rim Lining (1-10). Also shown is that the Body Cascading Door Zipper Tape Assembly (1-12) is place around the frontal opening formed generally by the openings of Vertical Body Member (1-1) and Body Base Member (1-2).

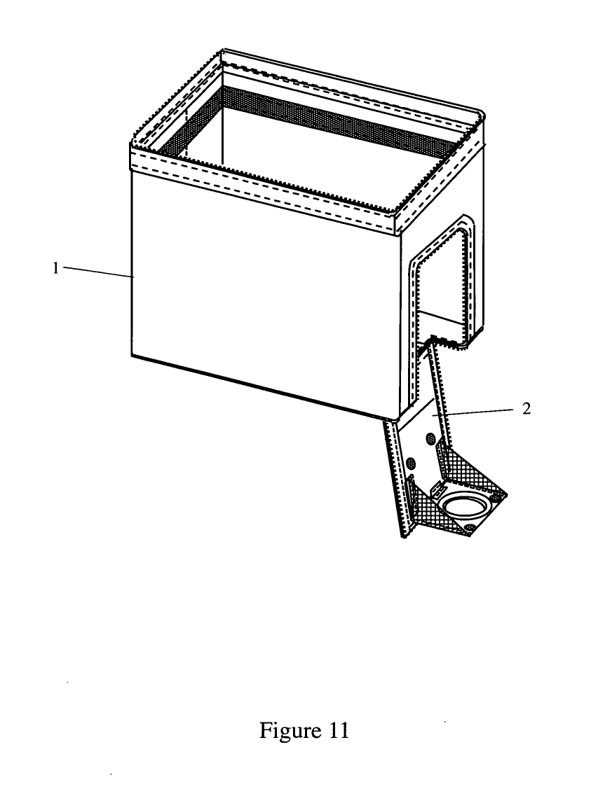

Referring to FIG. 11 all of the components described in FIG. 2 through FIG. 10 comprise the assembled Cooler Body (1). The Cascading Door (2) is attached to the Cooler Body (1) and is in the fully opened position.

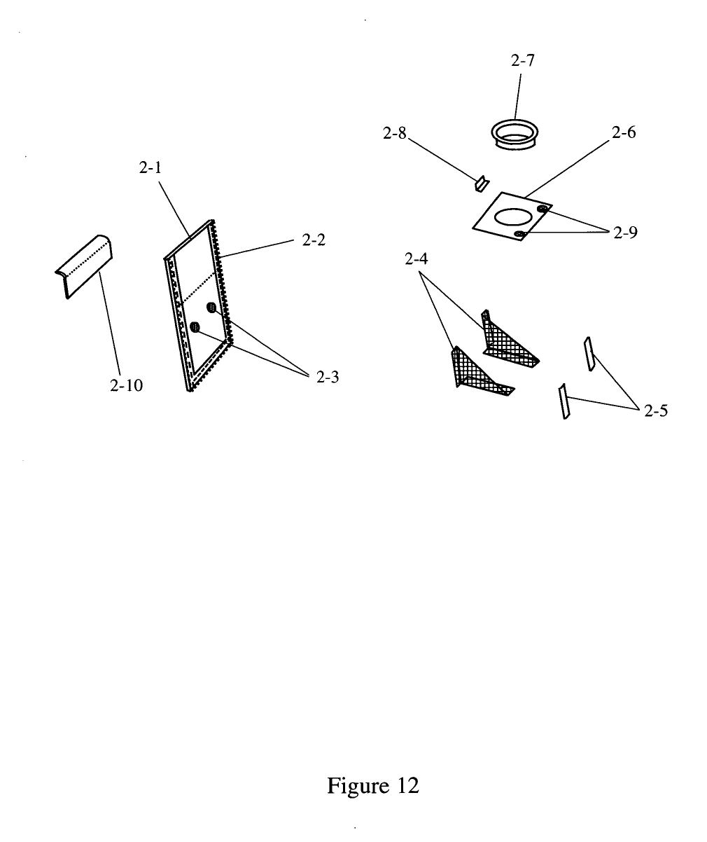

Referring to FIG. 12 the Cascading Door (2) described in FIG. 11 has a Cascading Door Member (2-1) that is sewn to the Cascading Door to Body Attachment Piece (2-10) which is sewn to the Cooler Body (1) depicted in FIG. 11. The Cascading Door Member (2-1) has attached the Cascading Door Zipper Tape (2-2), and Cup Holder Velcro Loop (2-3). The vertical and outward members of the Cup Holder Mesh Suspenders (2-4) are sandwiched between the Mesh Suspender Connecting Cover (2-5) and Cascading Door Member (2-1). The Mesh Suspender Connecting Cover (2-5) is sewn to the Cascading Door Member (2-1) and as such pinning the Cup Holder Mesh Suspenders (2-4) to the Cascading Door Member (2-1). The Cup Holder Body Plate (2-6) is a square piece with a circle cutout in its center. The Cup Holder Body Plate (2-6) is sewn to the folded member of Cup Holder Mesh Suspenders (2-4) which point towards each other. The Cup Holder Ring (2-7) is a structural reinforcing member that in placed inside of the circular cutout of the Cup Holder Body Plate (2-6) and sewn in place around its circular upper overlapping rim. The Cup Holder Body Plate (2-6) also has attached the Cup Holder Pivot Connector (2-8) which acts as a pivoting member. The Cup Holder Pivot Connector (2-8) is sewn to the Cascading Door Member (2-1). The Cup Holder Velcro Hook (2-9) has attached to it The Cup Holder Velcro Hook (2-9) which secures the cup holder formed by Cup Holder Mesh Suspenders (2-4), the Mesh Suspender Connecting Cover (2-5), Cup Holder Body Plate (2-6), and Cup Holder Ring (2-7) in place when folded about the Cup Holder Pivot Connector (2-8) against the Cascading Door Member (2-1). The Cup Holder Body Plate (2-6) has attached by an adhesive, the Cup Holder Velcro Hook (2-9) and the Cascading Door Member (2-1) also has attached to it the Cup Holder Velcro Loop (2-3) using an adhesive. Additionally, when the aforementioned cup holder formed by the Cup Holder Mesh Suspenders (2-4), Mesh Suspender Connecting Cover (2-5), Cup Holder Body Plate (2-6), and Cup Holder Ring (2-7) are folded about the Cup Holder Velcro Hook (2-9) the connection of the Cup Holder Velcro Hook (2-9) and Cup Holder Velcro Loop (2-3) serves to hold the cup holder formed by the Cup Holder Mesh Suspenders (2-4), Mesh Suspender Connecting Cover (2-5), Cup Holder Body Plate (2-6) and Cup Holder Ring (2-7) relatively flat against the Cascading Door Member (2-1).

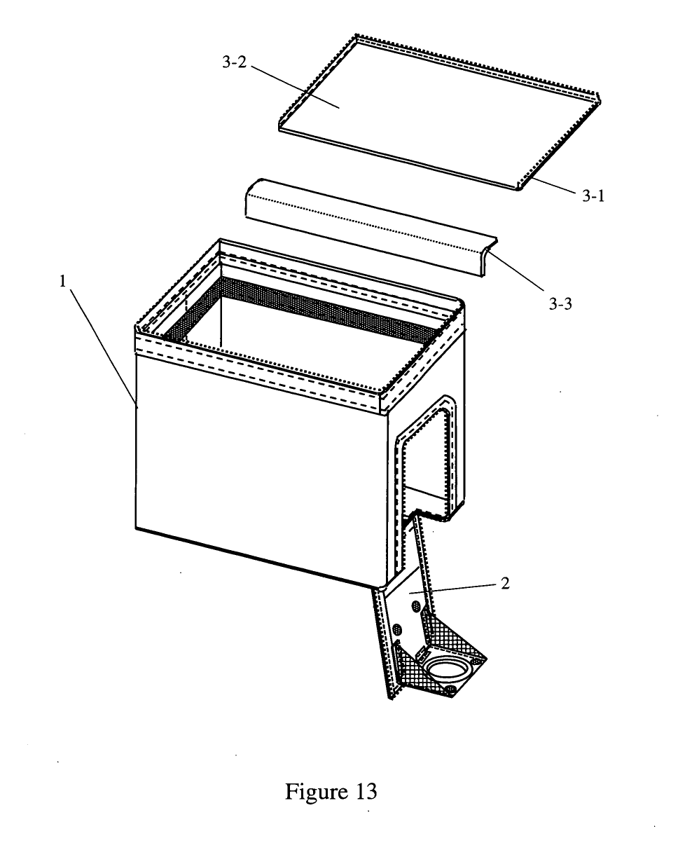

Referring to FIG. 13 the assembly described in FIG. 12 is collectively referred to as the Cascading Door (2) and is connected to the Cooler Body (1) as described in FIG. 12. The Cooler Lid Zipper Tape Assembly (3-1) is place on the Cooler Lid Body (3-2) and sewn to the Cooler Lid to Body Attachment Piece (3-3). The Cooler Lid to Body Attachment Piece (3-3) is sewn to the upper portion of the Cooler Body (1).

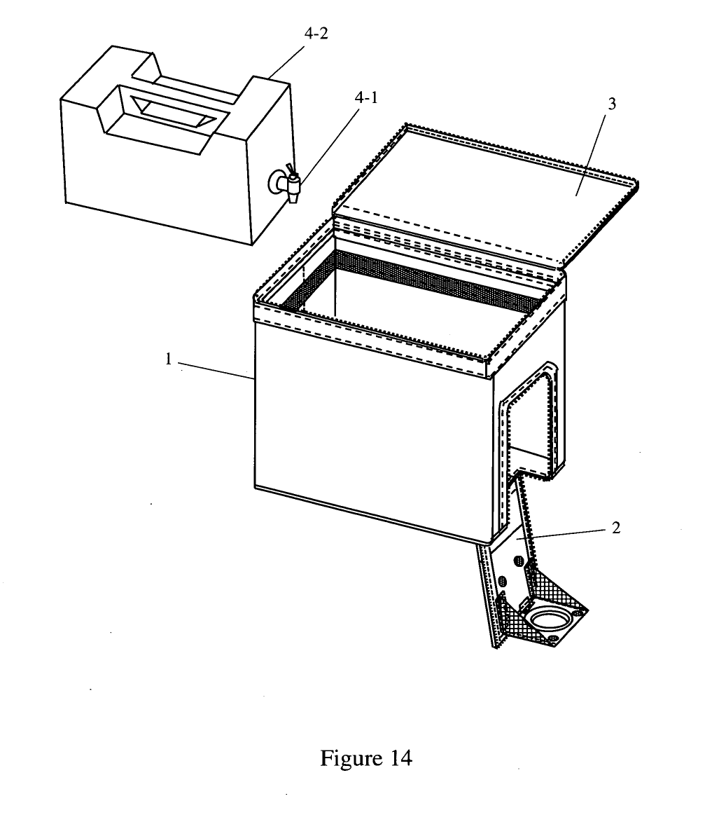

Referring to FIG. 14 the assembly described in FIG. 13 is referred to as the Cooler Lid (3) and is attached to the Cooler Body (1). The Fluid Reservoir (4-2) and Reservoir Nozzle (4-1) is place through the opening of the Cooler Body (1) that unconcealed by the Cooler Lid (3) being in the open position.

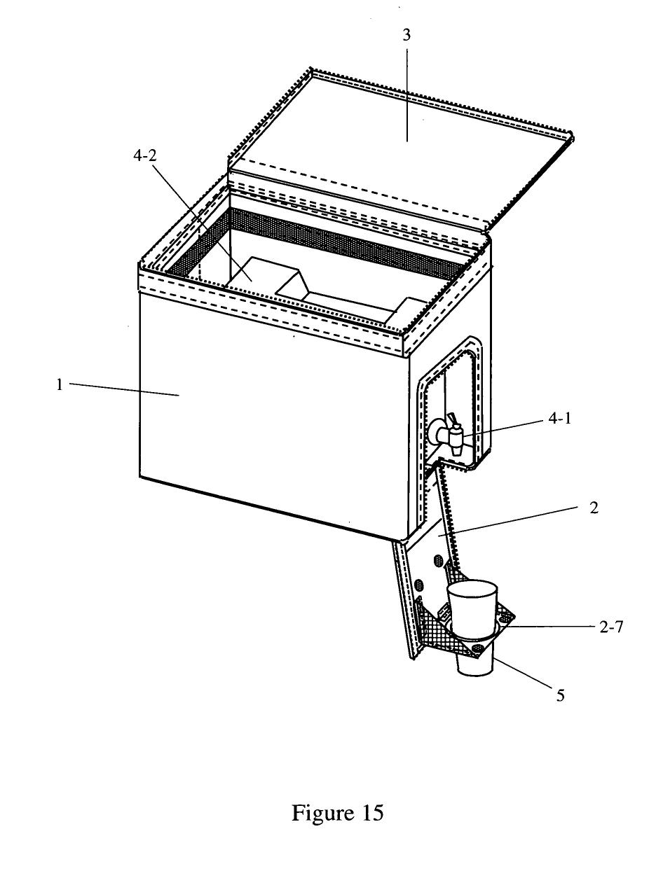

Referring to FIG. 15 the Fluid Reservoir (4-2) and Reservoir Nozzle (4-1) is seated inside of the Cooler Body (1). The Reservoir Nozzle (4-1) has an unimpeded fluid flow path that allows fluid leaving the Reservoir Nozzle (4-1) to accumulate in the Cup (5) which is sitting securely in the Cup Holder Ring (2-7).

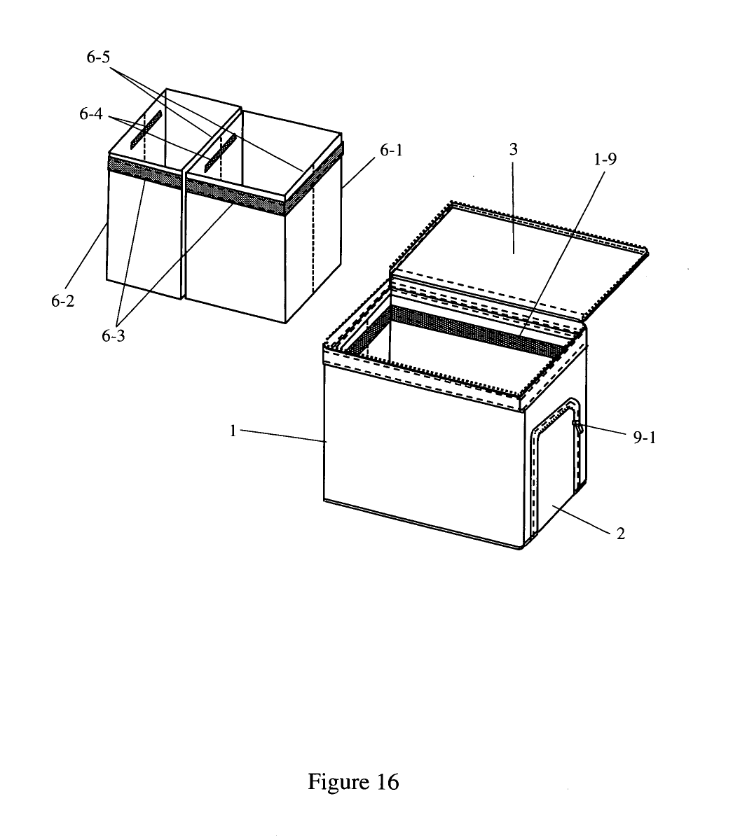

Referring to FIG. 16 the Forward Content Liner (6-1) is the forward water tight content liner that is made of a flexible water tight material and the Rear Content Liner (6-2) is a water tight content liner as well. The general area near the outside rim of the liners is surrounded with the Content Liner Outer Velcro Loop (6-3) which mates with the Body Inner Cavity Lining Velcro Hook (1-9) when either or both the Forward Content Liner (6-1) and Rear Content Liner (6-2) are placed in the Cooler Body (1). Inside of the Forward Content Liner (6-1) and Rear Content Liner (6-2) is the Content Liner Inner Velcro Hook (6-4) which is opposite of Content Liner Inner Velcro Loop (6-5) which is also inside the Forward Content Liner (6-1) and Rear Content Liner (6-2).

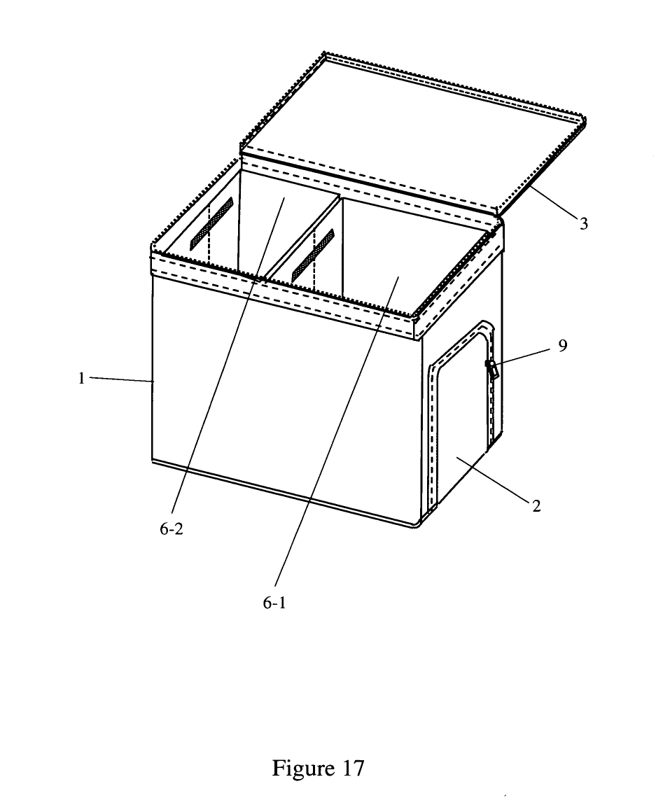

Referring to FIG. 17 The Forward Content Liner (6-1) and Rear Content Liner (6-2) are shown inside of Cooler Body (1) with the Cascading Door (2) in closed and Cooler Lid (3) opened.

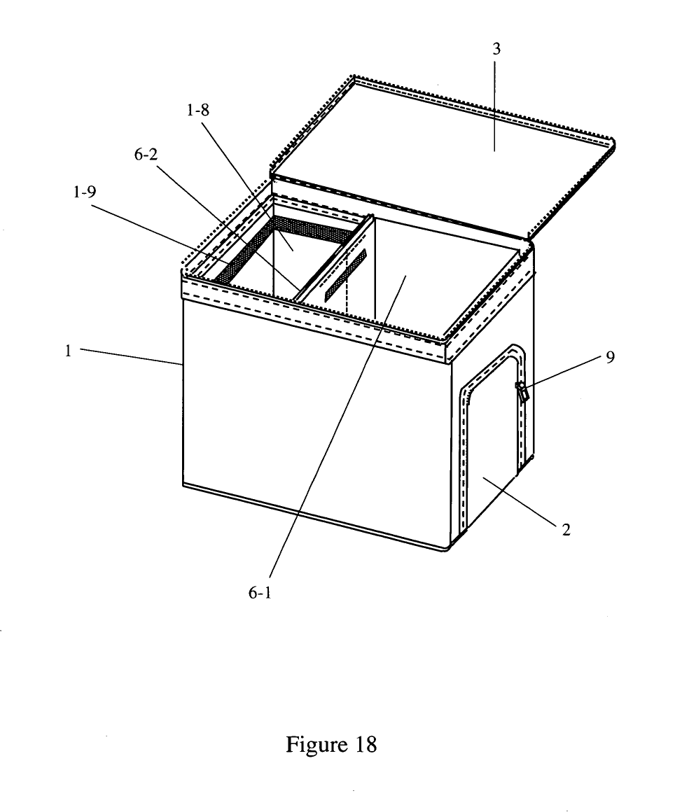

Referring to FIG. 18 The Rear Content Liner (6-2) is folded while still inside the Cooler Body (1) and the Forward Content Liner (6-1) is being used for contents with water tight requirements.

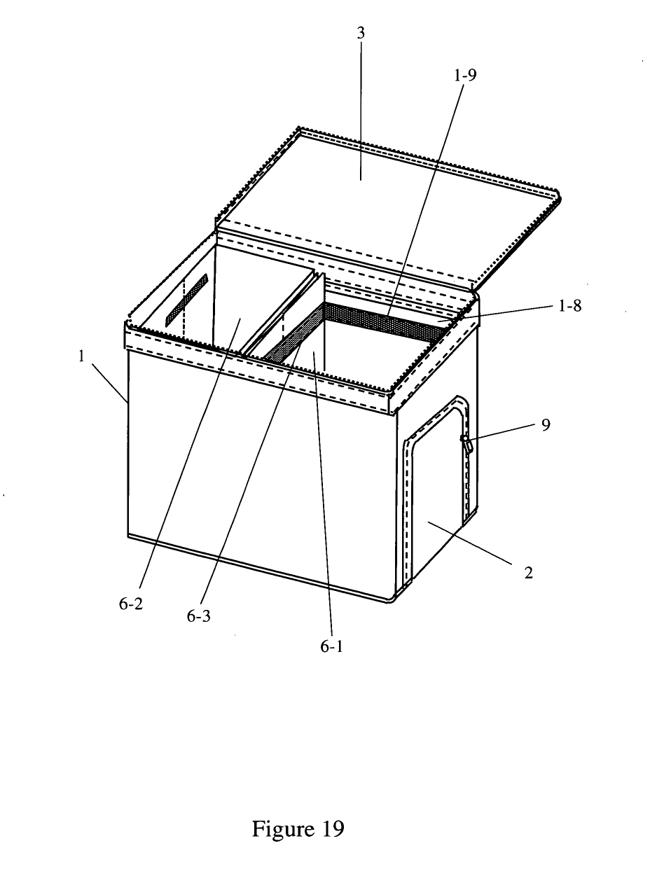

Referring to FIG. 19 The Rear Content Liner (6-2) is fully opened and the Forward Content Liner (6-1) is folded shut making room for items in the area previously occupied by the Forward Content Liner (6-1) to be access through the Cascading Door (2).

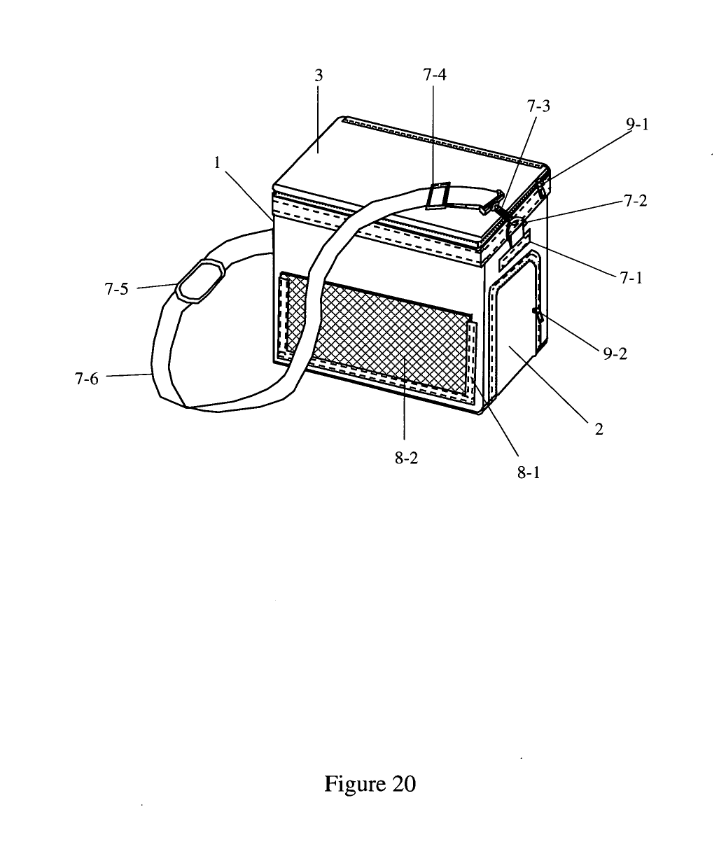

Referring to FIG. 20 the Handle Body Connector (7-1) is connected to the Cooler Body (1) and D-Ring Connector (7-2). The D-Ring Connector (7-2) in turn is connected to the Handle Strap (7-6) and Slide Adjust Buckles (7-4) which allow the length of the Handle Strap (7-6) to be adjusted. The Carrier Shoulder Pad (7-5) slides onto the Handle Strap (7-6). A configuration that mirrors the Handle Body Connector (7-1), D-Ring Connector (7-2), Snap Hook Buckle (7-3), and Slide Adjust Buckles (7-4) is present on the opposite side of Cooler Body (1). The Lid Zipper (9-1) allows the Cooler Lid (3) to be temporarily fastened to the Cooler Body (1) in the same manner that the Cascading Door Zipper (9-2) allows the Cascading Door (2) to be temporarily fastened to the Cooler Body (1). The Mesh Pocket Connection Liner (8-1) is sewn in place between the Pocket Mesh (8-2) and Cooler Body (1).

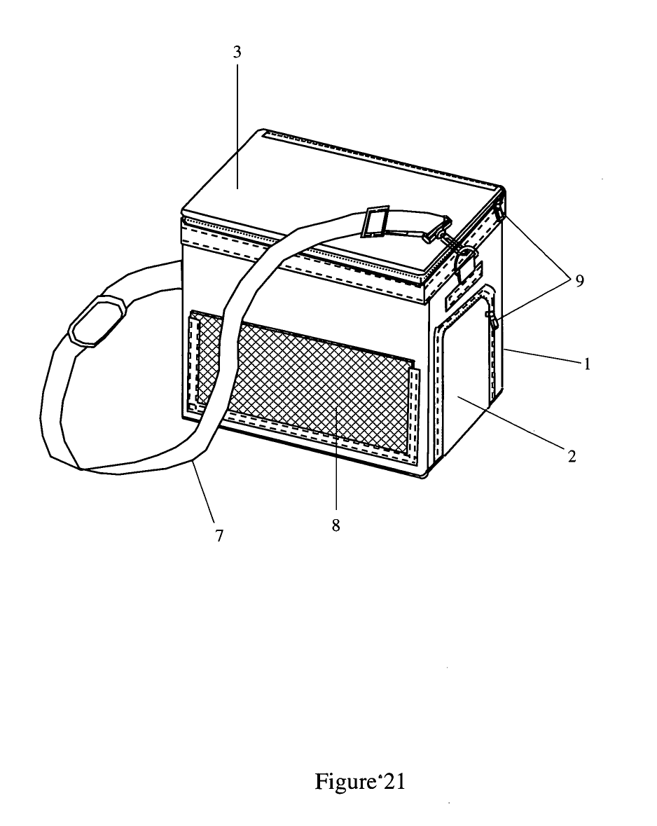

Referring to FIG. 21 the Detachable Cooler Handle (7) and the Side Pocket (8) are the collective names of the piece parts that comprise them.

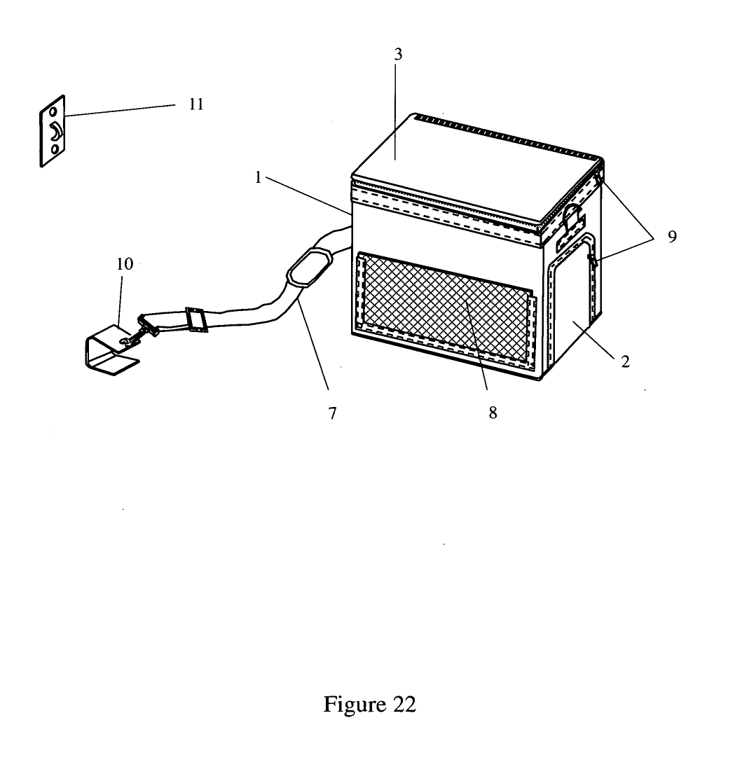

Referring to FIG. 22 the Detachable Cooler Handle (7) is connected to the Table Top Anchor (10) which is a flexible clamp with a loop form onto it for connecting the Detachable Cooler Handle (7). The Wall Mounted Anchor (11) is an alternate connection for the Detachable Cooler Handle (7). The Wall Mounted Anchor (11) has through holes for inserting screw or nail type fasteners so as to pin the Wall Mounted Anchor (11) to a wall type surface.

What is claimed as being new and desired to be protected is as follows:

1. A flexible cooler and dispenser alternative, comprising:
a Cooler Body with a Cooler Lid and a Cascading Door whereby the Cascading Door is for accessing a Reservoir Nozzle for uninstructed dispensing of the contents of a Fluid Reservoir into a Cup and wherein said Cascading Door has a Cup Holder mechanism attached;
a Content Management Insert that is removable and of variable dimensions whereby controlling the insulation characteristics of the Content Management Insert, arrangement of the Content Management Insert, and quantity of the Content Management Insert inside the Cooler Body; and
a Detachable Cooler Handle wherein said Detachable Handle connects to the Cooler Body on one end and connects to the Cooler Body, a Table Top Anchor, and a Wall Mounted Anchor on the opposite end whereby said Detachable Cooler Handle is for carrying the Cooler Body and restraining the Cooler Body.

2. A flexible cooler and dispenser alternative, comprising:
a Cooler Body with a Cooler Lid and a Cascading Door wherein said Cascading Door has a Cascading Door Member, a Cascading Door Zipper Tape, a plurality of Cup Holder Velcro Loops, a plurality of Cup Holder Mesh Suspenders, a plurality of Mesh Suspender Connecting Covers, a Cup Holder Body Plate, a Cup Holder Ring, a Cup Holder Pivot Connector, a plurality of Cup Holder Velcro Hooks, and a Cascading Door to Body Attachment Piece all of which to facilitate the option of supporting a cup when the Cascading Door is open and folding and maintaining flat against the Cascading Door when the Cascading Door is close and open;
a Content Management Insert that is removable and of variable dimensions for controlling the insulation characteristics of the Content Management Insert, arrangement of the Content Management Insert, and Quantity of the Content Management Insert inside the Cooler Body; and
a Detachable Cooler Handle with a plurality of Handle Body Connectors, a plurality of D-Ring Connectors, and a plurality of Snap Hook Buckles for connecting and disconnecting from the Cooler Body, a Slide Adjust Buckles for changing the length of the Detachable Cooler Handle, and a Handle Strap.
